(19) United States
(12) Patent Application Publication
(10) Pub. No.: US 2025/0208976 A1
(43) Pub. Date: Jun. 26, 2025

(54) VERIFICATION OF SOURCE CODE

(71) Applicant: Ocado Innovation Limited, Hatfield (GB)

(72) Inventors: Denys DYACHUK, Hatfield Hertfordshire (GB); Roman DZHADAN, Hatfield Hertfordshire (GB); Aleksandr DEMURA, Hatfield Hertfordshire (GB)

(21) Appl. No.: 19/076,912

(22) Filed: Mar. 11, 2025

Related U.S. Application Data
(63) Continuation of application No. PCT/EP2023/075048, filed on Sep. 12, 2023.

(30) Foreign Application Priority Data
Sep. 12, 2022 (GB) 2213316.9

(51) Int. Cl. G06F 11/3604

(52) U.S. Cl. CPC G06F 11/3608

(57) ABSTRACT

A method of automatically verifying source code is disclosed. The materials required to build source code are assembled at a first computing device. The materials are sent to a third computing device. If the materials are sent to a second computing device from the third computing device, the second computing device can automatically build the source from the materials.

### CROSS-REFERENCE TO RELATED APPLICATIONS

This application is a continuation of PCT International Application PCT/EP2023/075048, filed on Sep. 12, 2023, which claims priority to UK Application No. GB2213316.9, filed on Sep. 12, 2022, the entire contents of each of which are hereby incorporated by reference.

### TECHNICAL FIELD

Embodiments described herein relate to a method and system for verifying that source code held by a third party on behalf of first and second parties can be built.

### BACKGROUND

It is well known for a first party to provide computer and/or application programs to a second party under a licensing agreement. The licensing agreement may also require the first party to provide the source code of the computer and/or application programs to the second party when certain conditions are met. Such conditions include failure by the first party to maintain and/or update the computer and/or application programs, or bankruptcy/insolvency/administration of the first party. This ensures that the second party can continue to use and maintain the computer and/or application program, the use of which may be critical to the second party.

The first party may be reluctant to provide the source code to the second party unless one of the certain conditions has arisen. Equally, the second party may be concerned that when certain conditions have arisen, such as bankruptcy, it may be impossible for the first party to provide the source code. To address these conflicting interests, both the first and second parties may use a source code escrow service. Such a service is well known and involves both the first and second parties signing an escrow agreement/contract which determines the computer and/or application programs to be licensed and conditions under which the source code (of the licensed computer and/or application programs) belonging to the first party is released to the second party. The source code is then deposited with the provider (i.e. a third party) of the source code escrow service. Should the first party not meet the conditions of the escrow agreement, the third party releases the source code to the second party.

Although this provides the second party with the assurance that it will receive the source code when certain conditions are met, the source code itself may not be sufficient for the second party to continue its use of the computer and/or application program. For example, the source code may not actually be in a usable state such that an attempt by the second party to compile or build the source code results in failure. Thus, a second party may require verification that the source code deposited with the escrow service provider can in fact be built into working computer and/or application programs. Known solutions to this involve the escrow service provider witnessing and documenting the source code building process by the first party. Assuming the source code can be built, the documentation (i.e. a verification report) detailing the process is stored with the deposited source code. The second party can have a reasonable level of confidence that it can build the source code if need be. In other words, it has been verified that the deposited source code can be built into functioning computer and/or application programs.

However, the above process has certain drawbacks. When the licensing agreement covers a large number of computer and/or application programs, documenting the build process of the underlying source code for each computer and/or application program is a time intensive procedure. Additionally, the escrow agreement/contract may result in the number of computer and/or application programs increasing over time. This means new source code has to be verified and deposited on a continual basis. Accurately documenting the build process for each piece of source code can be prone to error given the third party's unfamiliarity with the first party's internal processes, such as where data is stored and how it can be retrieved. One further complication is that the source code may have dependencies. Dependencies indicate libraries, certificates, and settings that are required and retrieved for the source code to be built into an executable application. The verification report may indicate any such dependencies required. However, whilst the first party may currently have complete access to dependencies required to build the source code, the second party may not, such as dependencies residing at storage locations local to the first party. Thus, the second party may not be able to access the required dependencies to build the deposited source code, even though it has been verified by the third party.

There is a need for a reliable way for verifying source code that has been deposited with the source code escrow service provider. There is also a need to be able to build the deposited source code using only the data deposited with the source code escrow service provider.

### SUMMARY

In a first aspect, there is computer implemented method for preparing source code, the method comprising: retrieving source code of at least one computer program and/or application from at least one first storage location associated with a first computing device; scanning the source code to determine at least one build tool to build the source code; using the or each build tool to build the source code; and upon verifying that the source code can be built using the or each build tool, preparing at least one executable to build the source code using the or each build tool. This means the source code can be automatically built and verified by executing the executable.

The method of may further comprise depositing, at at least one third storage location associated with a third computing device, the source code, the or each build tool, and the or each executable. This means the third computing device can verify the source code by executing the executable.

Retrieving source code of the or each computer and/or application program may comprise identifying the or each computer and/or application program in an application registry, and using links in the application registry to retrieve the source code. This means the source code can be located in the at least one first storage location.

Using the or each build tool to build the source code may comprise using a build process comprising identifying at least one request for a dependency, wherein the dependency is stored in the at least one storage location associated with the first computing device, and/or external to the at least one storage location associated with the first computing device, and retrieving the or each requested dependency. This means all materials required to build and verify the source code have been obtained.

The at least one executable may replicate the build process whilst redirecting a request for at least one dependency to the or each retrieved dependency. This means that the build process can be completed without access to at least one storage location associated with the first computing device.

The or each retrieved dependency may be deposited at at least one third storage location associated with a third computing device. This means that the build process can be completed by the third computing device without access to the at least one storage location associated with the first computing device.

The method may further comprise selecting a plug-in to interact with a particular storage type of the at least one first storage location associated with the first computing device to retrieve the source code. This means the storage type can be automatically accessed.

The method may comprise obtaining permission to retrieve the source code before retrieving the source code. This means the source code is not inadvertently released by the first computing device.

The method may further comprise retrieving documentation and/or individual contact details associated with the source code, and depositing the documentation and/or the individual contact details associated with the source code at at least one third storage location associated with a third computing device. This means that all information relevant to building the source code has been received by the third computing device.

The or each executable may use operating system, OS, level virtualization to build the source code. This means the source code can be built efficiently by the third computing device.

The source code may be compressed and encrypted before depositing the source code at the or each third storage location associated with the third computing device. This reduces the transmission time and increases security during transmission.

At least one checksum is used to detect errors in the source code deposited at the or each third storage location associated with the third computing device. This means the deposited source code can be checked for errors.

The third computing device may confirm that the source code deposited at the or each third storage location associated with the third computing device has been received. This means the first computing device can verify the source code is now stored at a third storage location associated with the third computing device.

The source code deposited at the or each third storage location associated with the third computing device may be rolled back by the first party. This means an incomplete deposit, or one that is missing materials, can be removed.

The method may further comprise sending at least one of the source code, the or each build tool, the or each executable, the or each dependency, and documentation and/or individual contact details associated with the source code to at least one second storage location associated with a second computing device upon a condition being met. This means the second computing device has verified source code that can be built automatically by executing the executable.

In another aspect, there is a computer implemented method for receiving and verifying source code, the method comprising: receiving from a first computing device, at at least one third storage location associated with a third computing device, source code, at least one build tool, and at least one executable to build the source code; and optionally using the third computing device to execute the or each executable to build the source code using the or each build tool to verify the source code. This means the third computing device has the materials to optionally automatically build and verify the source code.

Executing the or each executable may comprise redirecting a request for at least one dependency to at least one dependency deposited at the or each third storage location associated with the third computing device. This means that the build process can be completed by the third computing device without access to at least one storage location associated with the first computing device.

Executing the executable may be in response to a request from a second computing device to verify the source code stored at the or each third storage location associated with the third computing device. The method may further comprise upon receiving the request from the second computing device, executing the or each executable to build the source code, and verifying, to the second computing device, whether the source code can be built. This means the second computing device receives confirmation it is able to use the source code.

The or each executable may use operating system, OS, level virtualization to build the source code. This means the source code can be built efficiently by the third computing device. The source code may be prepared according to the methods of the above aspects.

The method may comprise the third party computing device sending at least one of the source code, the or each build tool, the or each executable, the or each dependency, and documentation and/or individual contact details associated with the source code to at least one second storage location associated with a second computing device upon a condition being met. This means the second computing device has verified source code that can be built automatically by executing the executable.

In another aspect, there is a computer program comprising instructions which, when the program is executed by a computer, cause the computer to carry out the methods of the above aspects.

In another aspect, there is a data processing system comprising a processor configured to carry out the methods of the above aspects.

### BRIEF DESCRIPTION OF DRAWINGS

Embodiments described herein are described with reference to one or more exemplary embodiments as depicted in the accompanying drawings, wherein:

FIG. 1 shows a system used to carry out the an aspect;

FIG. 2 shows a method for preparing source code;

FIG. 3 shows a method for retrieving source code from at least one storage location associated with a first party;

FIG. 4 shows a method for building the source code into an executable application;

FIG. 5 shows a method for depositing source code at the or each third storage device associated with the third computing device; and

FIG. 6 shows a method for automating the methods of FIGS. 2 to 5.

### DETAILED DESCRIPTION

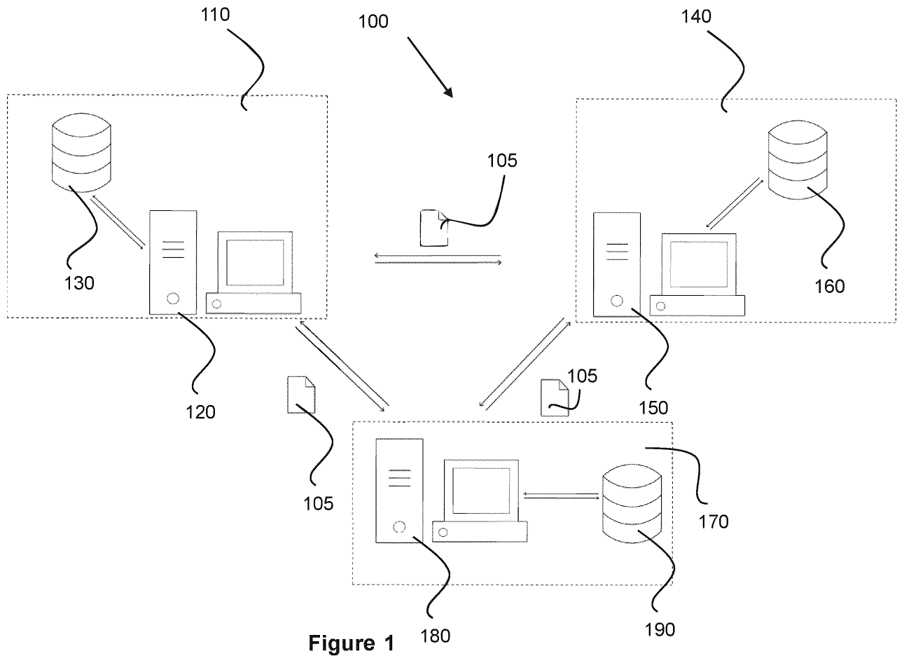

FIG. 1 shows a system 100 used to carry out an aspect. A first party 110 has a first computing device 120 and at least one first storage location 130 associated therewith. A second party 140 has a second computing device 150 and at least one second storage location 160 associated therewith. A third party 170 has a third computing device 180 and at least one third storage location 190 associated therewith. As shown in FIG. 1, there is two-way communication between each of the first, second, and third computing devices, to send files 105 for example. Similarly, each computing device has two-way communication with its respective storage location. It will be appreciated that the terms “first”, “second”, and “third” are merely nominal and are used to differentiate where certain actions/functions occur in the system. It will also be appreciated that the system of FIG. 1 can be implemented using respective hardware in respective locations. Alternatively, at least one of the first, second, and third computing devices, and/or the associated respective storage locations may be implemented in a cloud computing environment. Therefore, any combination of physical hardware and cloud computing environments may also be used to implement the system of FIG. 1. Example cloud computing environments include Amazon Web Services™, Microsoft Azure™, Google Cloud Platform™, and IBM Cloud™.

The system shown in FIG. 1 can be used to affect a source code escrow service. In this respect, the first party represents the licensor of the computer and/or application program to which the source code relates, the second party represents the licensee of the computer and/or application program to which the source code relates, and the third party represents the source code escrow service provider. The first computing device sends the computer and/or application program to the second computing device. The first party deposits the source code with the third party. The third party releases the source code to the second party according to conditions in the escrow agreement/contract. The system of FIG. 1 is further adapted to carry out the methods below.

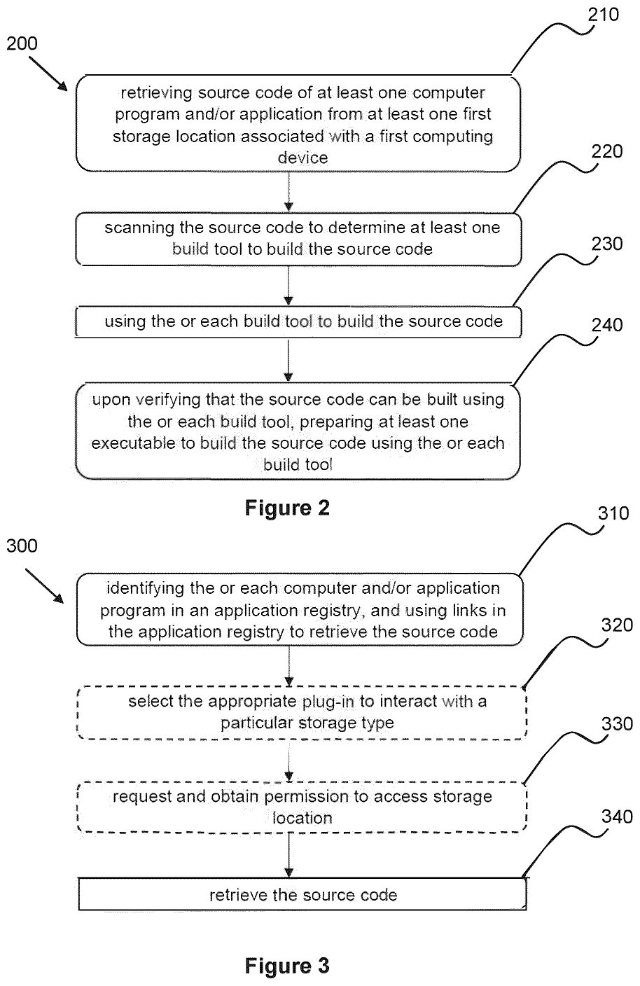

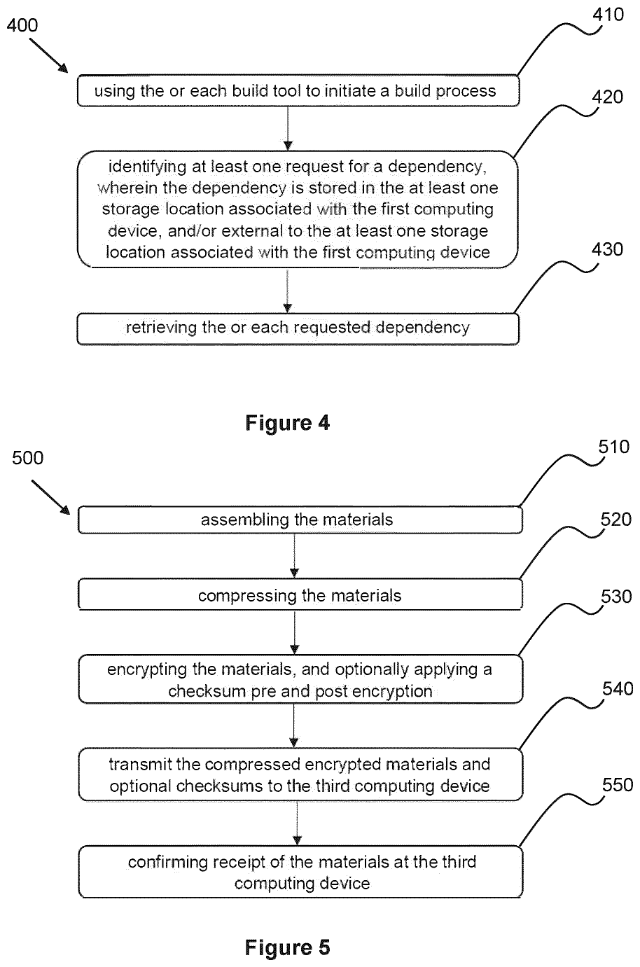

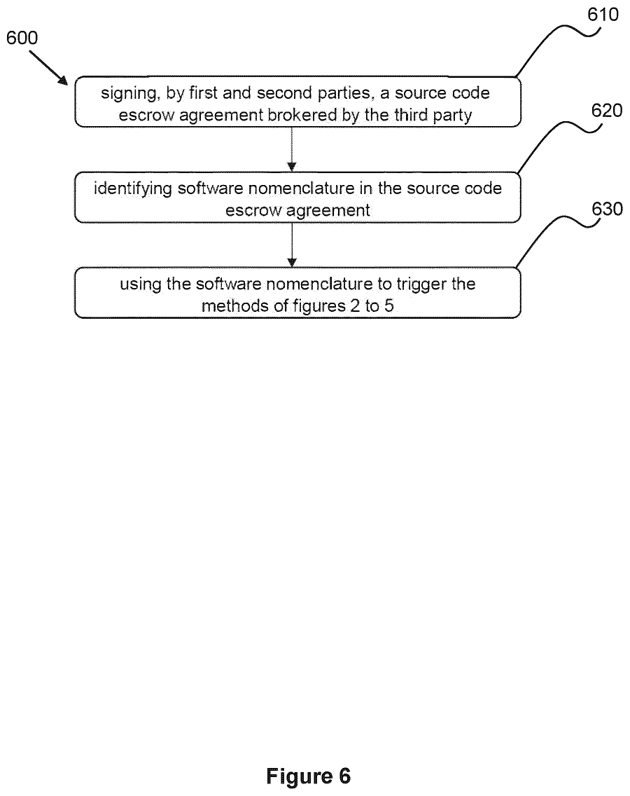

FIG. 2 shows the steps of a method 200 for preparing source code. The method 200 can be carried out by the first computing device 120. In step 210, source code of at least one computer and/or application program is retrieved from at least one storage location associated with a first party. The or each computer and/or application program may be covered by a licensing and/or escrow agreement between the first party and the second party.

Upon retrieving the source code of the or each computer and/or application program, the source code is analyzed to determine at least one build tool to build the source code at step 220. This can be achieved by scanning the source code to look for build tool files, which indicate the type of build tool to be used. For example, the build file name, pom.xml, indicates that a Maven™ build tool should be used, whereas the build file name, package.json, indicates that an Npm™ build tool should be used. It would be understood that a build tool creates an executable application (i.e. the licensed computer and/or application program) from the source code. It is possible that more than one build tool may be required for the source code, and the analyzing step 220 can identify all of the build tools that are required.

Now that the build tool for the source code is known, the known build tool can be used to build the source code into an executable computer and/or application program at step 230. Assuming an executable computer and/or application program is successfully built by the build tool, a corresponding executable can be generated at step 240. The executable, when executed, replicates the build process that has just resulted in an executable application.

One example of an executable is the script shown below. The script, when executed, uses OS-level virtualization provided by Docker™ to build a Docker image from a Dockerfile that contains the source code and a build tool for the source code. The Docker image can then be executed to build and verify the source code. The main advantage of using a script as the executable is that it can be easily edited. It will be appreciated that the script below and the principles on which it is based are merely representative.

```
#!/bin/bash
set -ex
usage( ) { echo “Usage: $0 [-c <yes|no>] [-d <build|load>] [-m <online|offline>]”
1>&2; exit 1; }
while getopts “:c:d:m:” o; do
  case “${0}” in
    c) c=${OPTARG};;
    d) d=${OPTARG};;
    m) m=${OPTARG};;
  esac
done
shift $((OPTIND-1))
if [[ ${c} != ‘yes’ && ${c} != ‘no’ ]]
then
  usage
else
  echo “Cache Usage = ${c}”
fi
if [[ ${d} != ‘build’ && ${d} != ‘load’ ]]
then
  usage
else
  echo “Docker Image Mode = ${d}”
fi
if [ ${m} != ‘online’ && ${m} != ‘offline’ ]]
then
  usage
else
  echo “Maven Goal Execution Mode = ${m}”
fi
if [[ ${d} == ‘build’ ]]
then
  cp -r /escrow/agreements/OCD00001/.binaries
/escrow/agreements/OCD00001/appRegistry/someApplication/repositories/13af7
2aa-ff6a-4e37-b957-
629c4f4f1a13/verifications/6e965ae4cf30211f7870e9afdc34dc54a7180a31/4c74b
1c7-727f-4f02-8727-09a8b58574c3/.binaries
  cp -r /escrow/agreements/OCD00001/.certificates
/escrow/agreements/OCD00001/appRegistry/someApplication/repositories/13af7
2aa-ff6a-4e37-b957-
629c4f4f1a13/verifications/6e965ae4cf30211f7870e9afdc34dc54a7180a31/4c74b
1c7-727f-4f02-8727-09a8b58574c3/.certificates
  docker build -t
escrow/maven/6e965ae4cf30211f7870e9afdc34dc54a7180a31:4c74b1c7-727f-
4f02-8727-09a8b58574c3 .
  rm -rf
/escrow/agreements/OCD00001/appRegistry/someApplication/repositories/13af7
2aa-ff6a-4e37-b957-
629c4f4f1a13/verifications/6e965ae4cf30211f7870e9afdc34dc54a7180a31/4c74b
1c7-727f-4f02-8727-09a8b58574c3/.binaries
  rm -rf
/escrow/agreements/OCD00001/appRegistry/someApplication/repositories/13af7
2aa-ff6a-4e37-b957-
629c4f4f1a13/verifications/6e965ae4cf30211f7870e9afdc34dc54a7180a31/4c74b
1c7-727f-4f02-8727-09a8b58574c3/.certificates
fi
if [[ ${d} == ‘load’ ]]
then
  echo “tbd in the future >>> docker load -- input /dockerimage.path” 1>&2
  exit 64
fi
if [[ ${m} == ‘offline’ ]]
then
  extraOfflineMavenArgument=“ -o”
fi
if [[ ${c} == ‘yes’ ]]
then
  extraCacheMavenArgument=“ -
Dmaven.repo.local=/escrow/agreements/OCD00001/.caches/.m2”
fi
docker run -it -- mount type=bind, src=/escrow,dst=/escrow -w
/escrow/agreements/OCD00001/appRegistry/someApplication/repositories/13af7
2aa-ff6a-4e37-b957-629c4f4f1a13/sources
escrow/maven/6e965ae4cf30211f7870e9afdc34dc54a7180a31:4c74b1c7-727f-
4f02-8727-09a8b58574c3 /bin/sh -c “mvn -s
/escrow/agreements/OCD00001/appRegistry/someApplication/repositories/13af7
2aa-ff6a-4e37-b957-
629c4f4f1a13/verifications/6e965ae4cf30211f7870e9afdc34dc54a7180a31/4c74b
1c7-727f-4f02-8727-09a8b58574c3/Mavensettings package -
Dmaven.test.skip=true -DskipTests -Dmaven.wagon.http.ssl.insecure=true -
Dmaven.wagon.http.ssl.allowall=true$extraOfflineMavenArgument$extraCache
MavenArgument”
```

Another example of the executable is a database and associated application program that could be written on Java™ for example. The database can be arranged to store data and use OS-level virtualization to build the source code. For example, the database could contain a Docker Image that has been built from a Dockerfile that contains the source code and a build tool for the source code. The data stored in the database is then called upon by the associated application program, when executed, to build the computer and/or application program. The main advantage of using a database and associated application program as the executable is that extra functionality can be easily added to the associated application program. Additionally, the associated application program can provide features like failure recovery, report logs, and previous verification results. It will be appreciated that the executable taking the form of database and associated application programs and the principles on which it is based are merely representative.

FIG. 3 shows the steps of a method 300 used to retrieve the source code from at least one storage location associated with a first party (i.e. step 210 of FIG. 2). The first computing device maintains an application registry at the first computing device that maps computer and/or application programs (i.e. those that are licensed by the first party to the second party) to repository links. The repository links could correspond to a Git™ repository, or a network drive folder for example. The application registry allows all storage locations associated with the first computing device that could contain the source code, to be accessed.

Step 310 identifies the or each computer and/or application program in the application registry and uses the application registry to provide access links to the storage locations associated with the first party that contain source code. The links in the application registry may indicate a type of storage. For example, if the link starts with ‘smb://’, the storage location is a network drive, whereas if the link starts with ‘git@’, the storage link is a Git™ repository. To retrieve the source code, a plug-in can be selected according to the storage type indicated by the link. Optional step 320 selects the appropriate plug in to interact with a particular storage type. The selected plug-in is configured to interact with a particular storage type so that source code can be retrieved.

Before being able to access the source code, appropriate permissions may be requested and obtained. Step 330 is therefore optional and requires permission to be both requested and obtained before the desired storage location can be accessed. This process may be automated in that an authorized computing device carries out the method of FIG. 3. Alternatively, an attempt to access the source code storage location automatically generates a permission request. Information in the application registry as to whom/where permission requests should be sent can be used for this purpose.

As well as retrieving the source code, documentation related to the source code may also be retrieved. The documentation provides a description of the source code that can assist with the building, maintenance, and updating thereof. Such documentation may be identified by file name, and for example Readme.md may indicate such documentation. Additionally, specific individuals responsible for developing the source code may be identified by analyzing comments on the source code. In step 340, the source code is retrieved. Optionally, documentation and/or individual contact details related to the retrieved source code is also received.

In addition to using the application registry, the method 300 may also check relevant locations in the at least one storage location associated with the first party. For example, some applications may be in a development phase or inadvertently omitted from the application registry. Accessing known locations such as a shared network folder or a Gitlab™ repository means relevant source code can still be retrieved.

Using the method of FIG. 3 is particularly advantageous when the number of computer and/or application programs licensed, the storage locations (across both extensive internal and external networks), and the permissions required are significant. Absent the method of FIG. 3, retrieving the source code becomes a burdensome process. Further, the use of the application registry means the method of FIG. 3 can be fully automated when executed on an authorized device (i.e. a device that has permission to access source code).

FIG. 4 shows the steps of a method 400 of using the build tool to build the source code into an executable application (i.e. step 230 of FIG. 2). In step 410, the or each build tool is used to initiate a build process. As part of the build process, a request for a dependency may occur. In step 420, a request for a dependency is identified, as well as the storage location from which the requested dependency is retrieved. The storage location from which the requested dependency is retrieved may be on the same internal network as the first computing device and/or an external network to which the first computing device has access. In step 430, the requested dependency is retrieved/downloaded/copied. In other words, a local copy of the dependency now exists.

As mentioned above, the executable, when executed, replicates the build process that has just resulted in an executable application (i.e. step 240 of FIG. 2). The executable can also replicate the build process whilst redirecting a request for the dependency to the retrieved dependency. This means that the build process is no longer reliant on access to a certain storage location within an internal and/or external network. Instead, the build process only requires access to a storage location containing the retrieved dependency. In other words, retrieving the dependency means the executable can build the source code on demand without requiring any external resources. The example script shown above can redirect a request for a dependency by changing the script parameter, -m <online/offline>. If <online> is set, the script uses the links of the repositories, and if <offline> is set, the script redirects a request for a dependency to a retrieved dependency. Alternatively, when a database and associated application program are used as the executable, the retrieved dependency can be stored in the database. The associated application program can redirect a request for a dependency to the retrieved dependency stored in the database.

In respect of the method of FIG. 2, the first computing device 220 can then deposit the source code, the build tool, and the executable at the or each third storage location 190 associated with the third computing device 180. This means that the executable, when executed at the third computing device, will build the source code. Given the executable replicates the build process successfully completed using the first computing device, the source code can be successfully built using the third computing device. The third computing device can thus verify the source code and indicate this to the second computing device. This is advantageous since the source code can be automatically verified by the third computing device by executing the executable. There is no need to analyze the source code to determine which build tools are required. This advantage also exists for the second computing device in the event that the third computing device releases source code and the executable thereto. The second computing device can build the source code automatically using the executable. In other words, the source code can thus be maintained and/or updated regardless of the computing device used. Additionally, the first computing device may download the deposited source code, build tool, and executable so that it too can verify whether the deposited source code can be successfully built. This ensures that there are no errors introduced when depositing the source code, build tool, and executable.

In respect of the method of FIG. 3, the first computing device 220 can also deposit documentation and/or individual contact details related to the deposited source code, at the third storage location associated with the third computing device. This could provide useful information to the second computing device in the event that the third computing device releases the source code, build tool, and executable thereto. In particular, the second computing device is given details for the building, maintenance, and updating of the source code.

In respect of the method of FIG. 4, any retrieved dependencies can also be deposited at the or each third storage location associated with the third computing device. This is particularly advantageous since the source code can be built and verified by the third computing device without access to the original storage location (i.e. those in a storage location associated with the first party) of a requested dependency. The executable deposited with the source code and build tool at the third storage location, when executed, will redirect any requests for dependencies to the locally stored retrieved dependencies. This means the source code can be built in an offline environment (i.e. no local or external network or internet access). This advantage also exists for the second computing device in the event that the third computing device releases the source code, build tool, executable, and dependencies thereto. The second computing device will be able to build the source code without access to the original storage location (i.e. those in a storage location associated with the first party) of a requested dependency.

When building the source code using the third computing device, the executable can use a virtual machine to build and verify the source code. Alternatively, the executable taking the form of a script can use operating system, OS, level virtualization to build and verify the source code. One such OS-level virtualization is that provided by Docker™, where the script is also deposited with a Dockerfile to build a Docker image, or alternatively the Docker image is retrieved from the database by the associated application program. The Docker image is then executed to build and verify the source code.

Whilst the methods of FIGS. 2 to 4 have been described as executing a single executable to build source code, it will be appreciated that these methods can use multiple executables to build the source code. In one implementation, the executable taking the form of a script, when executed, executes individual scripts in a determined order to use respective build tools to build the source code. In another implementation, the executable taking the form of a database and associated application program, when executed, uses different parts of the databased in a determined order to use respective build tools to build the source code.

FIG. 5 shows a method 500 for depositing source code at the or each third storage device associated with the third computing device. In step 510, the materials (i.e. source code, executable, documentation and/or individual contact details related to the deposited source code, and retrieved dependencies) are assembled as explained above in relation to FIGS. 1 to 4 using the first computing device. It would be appreciated that the materials can be deposited individually or as part of a single file from which they are extracted. In either case, at step 520, the materials are compressed. At step 530, the materials are encrypted using a public key provided by the third computing device. It will be appreciated that the materials can instead be compressed after they have been encrypted. A checksum may optionally be used on each of the un-encrypted and encrypted materials. Both checksums can be verified by the third computing device. At step 540, the compressed encrypted materials and checksums are transmitted to the third computing device. At step 550, the third computing device confirms receipt of the compressed encrypted materials and checksums. Documentation concerning the deposit of the materials may be automatically generated and provided to both the first and third computing devices. At optional step 560, the first computing device may download the deposited materials to confirm the deposited materials are not corrupt by using the generated checksums.

Prior to confirmation of the deposited materials being received from the third computing device, it is possible to request roll-back of the deposited materials. If a roll-back request is received form the first computing device before the third computing device has confirmed the deposit, the third computing device proceeds to delete the deposit.

It will be appreciated that when the third computing device verifies the deposited source code, the third computing device first decrypts the deposited materials using a private key. Whilst FIG. 5 has been described in the context of transmitting data from the first computing device to the third computing device, the same method can be used for data exchanges originating form the third computing device to either of the first or second computing devices, or from the second computing device to the third computing device.

FIG. 6 shows a method 600 in which the third party can automate the processes above. At step 610, the first and second parties sign a source code escrow agreement brokered by the third party. The agreement lists computer and/or application programs that will be provided by the first party to the second party. The computer and/or application programs may be identified using software nomenclature, such as a code name known to both the first and second parties. For example, if the computer and/or application programs is for grocery robots for use with the second party's system on an archipelago, the computer and/or application program in the agreement may be identified as “grobot archipelago”. After the agreement has been signed by both the first and second parties, any software nomenclature can be identified in step 620. The identification in step 620 may be carried out by either the first or third computing device. In either case, the first computing device is made aware of the software nomenclature. The software nomenclature can then be used with the application registry to filter applications that are tagged with the nomenclature. The source code covered by the agreement can therefore be easily retrieved and thus trigger the methods of FIGS. 2 to 5 in step 630.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments described herein can take the form of an entirely hardware embodiment, an entirely software embodiment or an embodiment containing both hardware and software elements.

Furthermore, embodiments described herein can take the form of a computer program embodied as a computer-readable medium having computer executable code for use by or in connection with a computer. For the purposes of this description, a computer readable medium can be any tangible apparatus that can contain, store, communicate, propagate, or transport the program for use by or in connection with the computer. Moreover, a computer-readable medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The flow diagrams in the figures illustrate the architecture, functionality, and operation of possible implementations of methods according to various embodiments. In this regard, each block in the flow diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the flow diagrams, and combinations of blocks in the flow diagrams, can be implemented by special purpose hardware-based systems that perform the specified functions or acts, or combinations of special purpose hardware and computer instructions.

It will be understood that the above description of is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the scope of this invention.

### Example Embodiments

The following is a non-exhaustive list of embodiments, which may be or are claimed.

Embodiment 1. A computer implemented method for preparing source code, the method comprising: retrieving source code of at least one computer program and/or application from at least one first storage location associated with a first computing device; scanning the source code to determine at least one build tool to build the source code; using the or each build tool to build the source code; and upon verifying that the source code can be built using the or each build tool, preparing at least one executable to build the source code using the or each build tool.

Embodiment 2. The method of embodiment 1, further comprising depositing, at at least one third storage location associated with a third computing device, the source code, the or each build tool, and the or each executable.

Embodiment 3. The method of embodiments 1 or 2, wherein retrieving source code of the or each computer and/or application program comprises: identifying the or each computer and/or application program in an application registry; and using links in the application registry to retrieve the source code.

Embodiment 4. The method of any preceding embodiment, wherein using the or each build tool to build the source code comprises using a build process comprising: identifying at least one request for a dependency, wherein the dependency is stored in the at least one storage location associated with the first computing device, and/or external to the at least one storage location associated with the first computing device; and retrieving the or each requested dependency.

Embodiment 5. The method of embodiment 4, wherein the at least one executable replicates the build process whilst redirecting a request for at least one dependency to the or each retrieved dependency.

Embodiment 6. The method of embodiment 5, wherein the or each retrieved dependency is deposited at at least one third storage location associated with a third computing device.

Embodiment 7. The method of any preceding embodiment, further comprising selecting a plug-in to interact with a particular storage type of the at least one first storage location associated with the first computing device to retrieve the source code.

Embodiment 8. The method of any preceding embodiment, wherein the method comprises obtaining permission to retrieve the source code before retrieving the source code.

Embodiment 9. The method of any preceding embodiment, wherein the executable comprises a script, or database and associated application program.

Embodiment 10. The method of any preceding embodiment, further comprising: retrieving documentation and/or individual contact details associated with the source code; and depositing the documentation and/or the individual contact details associated with the source code at at least one third storage location associated with a third computing device.

Embodiment 11. The method of any preceding embodiment, wherein the or each executable uses operating system, OS, level virtualization to build the source code.

Embodiment 12. The method of embodiments 2 to 11, wherein the source code is compressed and encrypted before depositing the source code at the or each third storage location associated with the third computing device.

Embodiment 13. The method of embodiments 2 to 12, wherein at least one checksum is used to detect errors in the source code deposited at the or each third storage location associated with the third computing device.

Embodiment 14. The method of embodiments 2 to 13, wherein the third computing device confirms that the source code deposited at the or each third storage location associated with the third computing device has been received.

Embodiment 15. The method of embodiments 2 to 14, wherein the source code deposited at the or each third storage location associated with the third computing device can be rolled back by the first party.

Embodiment 16. The method of embodiments 2 to 15, further comprising releasing the source code, the or each build tool, the or each executable, and optionally at least one dependency from at the or each third storage location associated with the third computing device to at least one storage location associated with a second computing device upon a condition being met.

Embodiment 17. A computer implemented method for receiving and verifying source code, the method comprising: receiving from a first computing device, at at least one third storage location associated with a third computing device, source code, at least one build tool, and at least one executable to build the source code; and optionally using the third computing device to execute the or each executable to build the source code using the or each build tool to verify the source code.

Embodiment 18. The method of embodiment 17, wherein executing the or each executable comprises redirecting a request for at least one dependency to at least one dependency deposited at the or each third storage location associated with the third computing device.

Embodiment 19. The method of embodiments 17 or 18, wherein executing the executable is in response to a request from a second computing device to verify the source code stored at the or each third storage location associated with the third computing device.

Embodiment 20. The method of embodiment 19, the method further comprising: upon receiving the request from the second computing device, executing the or each executable to build the source code; and verifying, to the second computing device, whether the source code can be built.

Embodiment 21. The method of any one of embodiments 17 to 20, wherein the or each executable uses operating system, OS, level virtualization to build the source code, and/or wherein the executable comprises a script, or database and associated application program.

Embodiment 22. The method of embodiment 21, wherein the source code is prepared according to the methods of embodiments 1 to 16.

Embodiment 23. The method of embodiments 17 to 22, the method comprising the third party computing device sending at least one of the source code, the or each build tool, the or each executable, the or each dependency, and documentation and/or individual contact details associated with the source code to at least one second storage location associated with a second computing device upon a condition being met.

Embodiment 24. A computer program comprising instructions which, when the program is executed by a computer, cause the computer to carry out the method of embodiments 1 to 23.

Embodiment 25. A data processing system comprising a processor configured to carry out the method of embodiments 1 to 23.

Embodiment 26. A computer implemented method for requesting verification of source code, the method comprising: sending a request to a third computing device to verify source code stored at at least one third storage location associated with the third computing device; and receiving from the third computing device a verification as to whether the source code can be built.

Embodiment 27. The method of embodiment 26, wherein the source code is prepared according to the methods of embodiments 1 to 16.

Embodiment 28. The method of embodiments 26 or 27, wherein the source code is verified using the methods of embodiments 17 to 23.

Embodiment 29. A computer implemented method for depositing and verifying source code, the method comprising: retrieving source code of at least one computer program and/or application from at least one first storage location associated with a first computing device; scanning the source code to determine at least one build tool to build the source code; using the at least one build tool to build the source code; upon verifying that the source code can be built using the build tool, preparing at least one executable to build the source code using the or each build tool; depositing at at least one third storage location associated with a third computing device, the source code, the or each build tool, and the or each executable; optionally receiving, by the third computing device, a request from a second computing device to verify the source code deposited at the or each third storage location associated with the third computing device; optionally executing, by the third computing device, the or each executable to build the source code using the or each build tool to verify the source code; and optionally verifying, by the third computing device, to the second computing device whether the source code can be built.

Embodiment 30. The method of embodiment 29, wherein retrieving source code of the or each computer and/or application program comprises: identifying the or each computer and/or application program in an application registry; and using links in the application registry to retrieve the source code.

Embodiment 31. The method of embodiments 29 or 30, wherein using the or each build tool to build the source code comprises using a build process comprising: identifying at least one request for a dependency, wherein the dependency is stored in the at least one storage location associated with the first computing device, and/or external to the at least one storage location associated with the first computing device; and retrieving the or each requested dependency.

Embodiment 32. The method of embodiment 31, wherein the at least one executable replicates the build process whilst redirecting a request for at least one dependency to the or each retrieved dependency.

Embodiment 33. The method of embodiment 32, wherein the or each retrieved dependency is deposited at at least one third storage location associated with a third computing device.

Embodiment 34. The method of embodiments 29 to 33, further comprising selecting a plug-in to interact with a particular storage type of the at least one first storage location associated with the first computing device to retrieve the source code.

Embodiment 35. The method of embodiments 29 to 34, wherein the method comprises obtaining permission to retrieve the source code before retrieving the source code.

Embodiment 36. The method of embodiments 29 to 35, further comprising: retrieving documentation and/or individual contact details associated with the source code; and depositing the documentation and/or the individual contact details associated with the source code at at least one third storage location associated with a third computing device.

Embodiment 37. The method of embodiments 29 to 36, wherein the executable comprises a script, or database and associated application program.

Embodiment 38. The method of embodiments 29 to 37, wherein the or each executable uses operating system, OS, level virtualization to build the source code.

Embodiment 39. The method of embodiments 29 to 38, wherein the source code is compressed and encrypted before depositing the source code at the or each third storage location associated with the third computing device.

Embodiment 40. The method of embodiments 29 to 39, wherein at least one checksum is used to detect errors in the source code deposited at the or each third storage location associated with the third computing device.

Embodiment 41. The method of embodiments 29 to 40, wherein the third computing device confirms that the source code deposited at the or each third storage location associated with the third computing device has been received.

Embodiment 42. The method of embodiments 29 to 40, wherein the source code deposited at the or each third storage location associated with the third computing device can be rolled back by the first party.

Embodiment 43. The method of embodiments 29 to 41, further comprising releasing the source code from at the or each third storage location associated with the third computing device to at least one storage location associated with a second computing device upon a condition being met.

Embodiment 44. A computer implemented for preparing source code, the method comprising: analyzing, using a third computing device, a contract brokered by a third party on behalf of a first party and second party for the first party to license one computer program and/or application to the second party, wherein the analyzing extracts software nomenclature; using, by a first computing device, the software nomenclature to retrieve source code of at least one software application in at least one first storage location associated with the first computing device; scanning the source code to determine at least one build tool to build the source code; using the at least one build tool to build the source code; upon verifying that the source code can be built using the build tool, preparing at least one executable to build the source code.

Embodiment 45. The method of embodiment 44, further comprising depositing, at at least one third storage location associated with a third computing device, the source code, the or each build tool, and the or each executable.

Embodiment 46. The method of embodiments 44 or 45, wherein retrieving source code of the or each computer and/or application program comprises: identifying the or each computer and/or application program based on the software nomenclature in an application registry; and using links in the application registry to retrieve the source code.

Embodiment 47. The method of embodiments 44 to 46, wherein using the or each build tool to build the source code comprises using a build process comprising: identifying at least one request for a dependency, wherein the dependency is stored in the at least one storage location associated with the first computing device, and/or external to the at least one storage location associated with the first computing device; and retrieving the or each requested dependency.

Embodiment 48. The method of embodiment 47, wherein the at least one executable replicates the build process whilst redirecting a request for at least one dependency to the or each retrieved dependency.

Embodiment 49. The method of embodiment 48, wherein the or each retrieved dependency is deposited at at least one third storage location associated with a third computing device.

Embodiment 50. The method of embodiments 44 to 49, further comprising selecting a plug-in to interact with a particular storage type of the at least one first storage location associated with the first computing device to retrieve the source code.

Embodiment 51. The method of embodiments 44 to 50, wherein the method comprises obtaining permission to retrieve the source code before retrieving the source code.

Embodiment 52. The method of embodiments 44 to 51, further comprising: retrieving documentation and/or individual contact details associated with the source code; and depositing the documentation and/or the individual contact details associated with the source code at at least one third storage location associated with a third computing device.

Embodiment 53. The method of embodiments 44 to 52, wherein the executable comprises a script, or database and associated application program.

Embodiment 54. The method of embodiments 44 to 53, wherein the or each executable uses operating system, OS, level virtualization to build the source code.

Embodiment 55. The method of embodiments 44 to 54, wherein the source code is compressed and encrypted before depositing the source code at the or each third storage location associated with the third computing device.

Embodiment 56. The method of embodiments 44 to 55, wherein at least one checksum is used to detect errors in the source code deposited at the or each third storage location associated with the third computing device.

Embodiment 57. The method of embodiments 45 to 56, wherein the third computing device confirms that the source code deposited at the or each third storage location associated with the third computing device has been received.

Embodiment 58. The method of embodiments 45 to 57, wherein the source code deposited at the or each third storage location associated with the third computing device can be rolled back by the first party.

Embodiment 59. The method of embodiments 45 to 58, further comprising releasing the source code from at the or each third storage location associated with the third computing device to at least one storage location associated with a second computing device upon a condition being met.

Embodiment 60. A computer program comprising instructions which, when the program is executed by a computer, cause the computer to carry out the method of embodiments 26 to 59.

Embodiment 61. A data processing system comprising a processor configured to carry out the method of embodiments 26 to 59.

What is claimed is:

1. A computer implemented method for preparing source code, comprising:
retrieving source code of a computer program or an application from a first storage location associated with a first computing device;
scanning the source code to determine a build tool to build the source code;
using the build tool to build the source code; and
upon verifying that the source code can be built using the build tool, preparing an executable to build the source code using the build tool.

2. The method of claim 1, further comprising depositing, in a third storage location associated with a third computing device, the source code, the build tool, and the executable.

3. The method of claim 1, wherein retrieving source code of the computer or the application program comprises:
identifying the computer or the application program in an application registry; and
using links in the application registry to retrieve the source code.

4. The method of claim 1, wherein using the build tool to build the source code comprises using a build process comprising:
identifying a request for a dependency, wherein the dependency is stored in the storage location associated with the first computing device or external to the storage location associated with the first computing device; and
retrieving the dependency associated with the request.

5. The method of claim 4, wherein the executable replicates the build process whilst redirecting the request for the dependency to the retrieved dependency.

6. The method of claim 5, wherein the retrieved dependency is deposited in a third storage location associated with a third computing device.

7. The method of claim 1, further comprising selecting a plug-in to interact with a particular storage type of the first storage location associated with the first computing device to retrieve the source code.

8. The method of claim 1, wherein the method comprises obtaining permission to retrieve the source code before retrieving the source code.

9. The method of claim 1, wherein the executable comprises a script, or database and associated application program.

10. The method of claim 1, further comprising:
retrieving documentation or individual contact details associated with the source code; and
depositing the documentation or the individual contact details associated with the source code in a third storage location associated with a third computing device.

11. The method of claim 1, wherein the executable uses operating system level virtualization to build the source code.

12. The method of claim 10, wherein the source code is compressed and encrypted before depositing the source code in the third storage location associated with the third computing device.

13. The method of claim 2, wherein a checksum is used to detect errors in the source code deposited at the third storage location associated with the third computing device.

14. The method of claim 2, wherein the third computing device confirms that the source code deposited at the third storage location associated with the third computing device has been received.

15. The method of claim 2, wherein the source code deposited at the third storage location associated with the third device can be rolled back by a first party.

16. The method of claim 4, further comprising sending at least one of the source code, the build tool, the executable, the dependency, documentation, or individual contact details associated with the source code to a second storage location associated with a second computing device upon a condition being met.

17. A computer program comprising instructions which, when the program is executed by a computer, cause the computer to carry out a method comprising:
retrieving source code of a computer program or an application from a first storage location associated with a first computing device;
scanning the source code to determine a build tool to build the source code;
using the build tool to build the source code; and
upon verifying that the source code can be built using the build tool, preparing an executable to build the source code using the build tool.

18. A data processing system comprising a processor configured to cause the data processing system to:
retrieve source code of a computer program or an application from a first storage location associated with a first computing device;
scan the source code to determine a build tool to build the source code;
use the build tool to build the source code; and
upon verifying that the source code can be built using the build tool, prepare an executable to build the source code using the build tool.
